(19) United States
(12) Patent Application Publication
(10) Pub. No.: US 2006/0284573 A1
(43) Pub. Date: Dec. 21, 2006

(54) System for Controlling and Regulating Continuously the Luminous Flow of Every Single Lamp Derived on a Parallel Line

(76) Inventors: Vincenzo Ferraro, Rende (IT); Menuccia Alessia Ferraro, Rende (IT); Emilio Ferraro, Rende (IT)

Correspondence Address: SMITH HOPEN, PA, 180 PINE AVENUE NORTH, OLDSMAR, FL, 34677, US

(21) Appl. No.: 11/160,333

(22) Filed: Jun. 20, 2005

(51) Int. Cl. H05B 39/00

(52) U.S. Cl. 315/312

(57) ABSTRACT

This system, valid for any type of lamp (both those with a filament and those with a gas discharge), permits the continuous control and regulation, on a distribution network, of the luminous flow of each single lamp that is connected to it in parallel. The system, as can be seen in FIG. 1, is characterised by two sections, one inserted at the beginning of the branching of the distribution network, the “General Control Module”, and one inserted on each single lamp, the “Module of Control and Regulation of the Luminous Flow”, whose functions can be synthesised thus: 1. The “MODULE OF CONTROL AND REGULATION OF THE LUMINOUS FLOW” is a regulator of partialisation of phase that, thanks to a specific electronics of elaboration, runs the lamp connected to it, so that this operates with the programmed functional parameters. 2. The “GENERAL CONTROL MODULE” has, instead, the double job of: generating the most suitable form of wave (in frequency and in form) that the specific application needs, and actuating, contemporarily, the proper correction of the power factor on the network of incoming feed, in order to return it within the limits of acceptance demanded by regulations. The information that ties the operations of the “General Control Module” to that of the single “Module of Control and Regulation of the Luminous Flow” are actuated with a transmission/reception of conveyed waves that, aside from the executive commands, also permits an accurate analysis of the functional state of the lamp and its auxiliary circuits.

### CROSS REFERENCE TO RELATED APPLICATIONS

The present application is a U.S. National Stage application claiming the benefit of prior filed International Application, serial number PCT/IT2003/000826, filed on Dec. 17, 2003, which International Application claims a priority date of Dec. 20, 2002 based on prior filed Czech Republic patent application serial number No CZ2002A000013.

### DESCRIPTION

### State of the Art

In this period, in which great attention is given to the problems of energy saving and the quality of services offered to citizens, the public illuminations systems are the subject of notable industrial interest, both for the quantity of electrical energy to which they refer and for the problems of “citizens' safety” that they can resolve.

A series of studies exist which demonstrate how harmful it is to charge the lamps with a voltage greater than 5% of its nominal value. Thus it appears evident how the greater voltage present on the electricity network during the night compromises the lamps connected to it under both the profile of their life and for the quantity of luminous flow emitted during their life cycle.

Furthermore, the quantity of energy utilised often results as excessive in respect to the real needs of the community.

There are, in fact:

oversized equipment in relation to the needs, for example, of countryside roads or secondary roads illuminated by lamps exceeding the real needs;

equipment that functions at full regime throughout the night, without effecting a reduction in the luminous flow;

monuments with excessive illumination and/or a diffusion of the light far beyond the outline of the shape and not subject to a programmed turning off.

With the scope of reducing the consumption of electrical energy in relation to public illuminations it is therefore necessary to:

effect a reduction in the luminous flow emitted by the lamps during the night hours of lesser necessity;

supply the luminous fonts with a stable voltage level;

regulate the turning on and turning off in such a way as to make the best use of natural light;

utilise luminous fonts of maximum efficiency;

thus on the market at present there are already both “monitoring systems”, that control the state of the lamps and the auxiliary circuitry, as well as “operating systems” that actuate the regulation of the luminous flow (and therefore energy saving) according to the parameters of the ambient light and the time phases in function.

Systems of these types present the grave design handicap of most of the auxiliaries that characterize the circuit, so the real problem today is not “technological”, rather that of the “configuration to construct” to obtain excellent functionality at a low cost.

The solutions present on the market today are many and fundamentally mirror the following “basic solutions”:

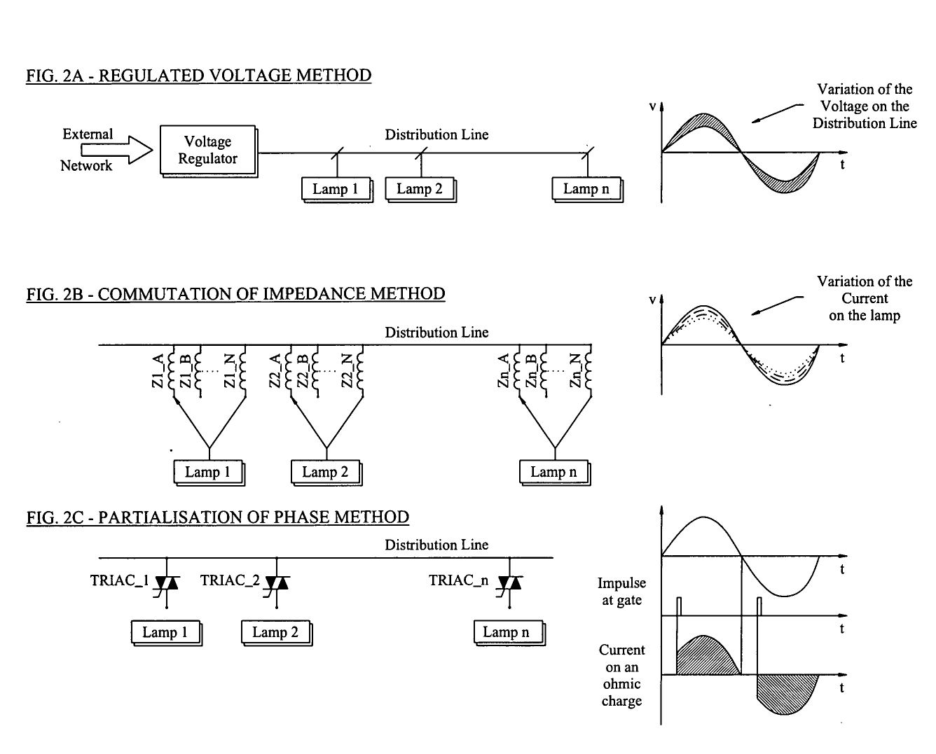

“Method of regulation of voltage”. The general scheme of this method is shown in FIG. 2A. At the entrance of the external network a voltage regulator is placed, on the outlets of which the distribution network that feeds the lamps is connected. In this way we obtain, according to the programming present on the voltage regulator, the turning on of the lamps with a variable luminous flow dependent on the feed voltage supplied.

The intrinsic disadvantages that characterise this technological solution are:

1.1.1. The impossibility of regulating the lamps in a specific manner; a fact of notable disadvantage when there are branches of various type, as in the case of main roads and secondary roads and/or historic monuments or tunnels, present on the same distribution line.

1.1.2. The impossibility to compensate, between the first and final lamp, the drops in voltage level present on the distribution line, a fact that means not being able to optimize the luminous flow in a constant manner, above all in the case of very extensively spread distribution lines.

1.2. “Method of commutation of impedance”. The general design of this method is shown in FIG. 2B. in this case, each single lamp is given an impedance commutator and this permits the regulation of the most adapt luminous flow on each one. In this way we obtain, according to the programme present on the control system, that each single lamp can be fed in such a way as to obtain the luminous flow desired.

This method, faultless from a design concept point of view, has the disadvantage of needing a hardware section of notable cost and dimension, a fact that in practical applications brings about the use of only two or three commutations and thus the following intrinsic disadvantages:

1.2.1. The impossibility of stabilising the desired luminosity on the regulated lamp, since the number of commutations available is extremely reduced. A much felt problem with incandescent light bulbs because, with them, the energy consumed is not proportionate to the feed of voltage, on the contrary an ample variation of the luminous flow can be regulated in a rather restricted range of voltage. It becomes, furthermore, economically costly to stabilize the luminous flow in variation with the nominal conditions of the parameters of the external network.

1.2.2. Difficulties in adapting its hardware in the standard spaces predisposed for the auxiliary circuitry. A fact that often leads to predisposing systems that do not exceed two commutations.

To these two schematic basic conceptions it is obviously possible to effect variations and/or integrate them together to mitigate the disadvantages; this conceptual problem remains evident, however: the best results are obtained by having available a high number of intermediate stages for regulating the luminous flow of each single point of light. A fact that becomes possible at a relatively high cost with the present technological proposals.

An alternative solution to those already illustrated consists in using the technique of “The Partialisation of Phase”, as can be seen in FIG. 2.C, a well-known method whose “fundamental advantages” are:

2.1. Greatly reduced cost, therefore the possibility to insert it onto every light point control without particular economic disadvantages;

2.2 The possibility of regulating to a high definition the energy to be supplied to the specific point of light to which it is connected.

2.3. Operating highly efficiently, typical of the circuits that function with a low number of commutations; on the other hand the notable “disadvantages” that characterise a system of the type are: 3.1.

3.1. Not being able to use it on the external network, because of the high harmonics that the method generates (specific regulations forbid the use);

3.2. Operating in a very low execution dynamic. For example, in use in the TRIAC power systems, only a single control per wave semi-period is possible (TRIACs are components which, if activated, turn off only at the passage of current to zero), that is, one control every 10 ms if the frequency is 50 Hz.

### DESCRIPTION

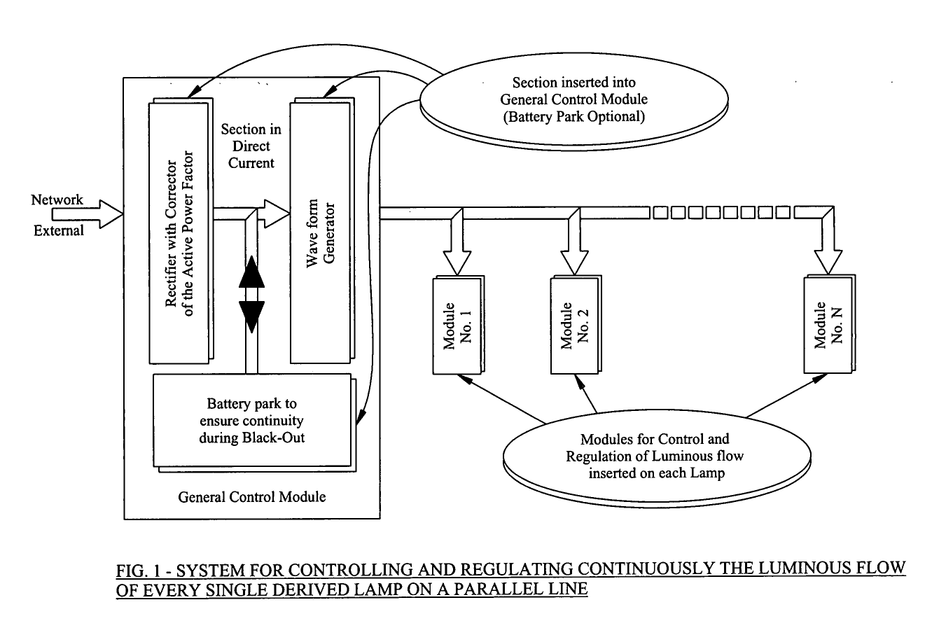

The general design of the apparatus constructed by us is shown in FIG. 1. Said apparatus is based on the presence of two principal modules, the GENERAL CONTROL MODULE that is placed at the entrance to the external feed network and provides to feed the “Distribution line”, where various MODULES FOR THE CONTROL AND REGULATION OF LUMINOUS FLOW are situated.

The scope of the GENERAL CONTROL MODULE is that of stabilising the quantity of

energy transferred to the lamps, while the scope of the MODULE FOR THE CONTROL AND REGULATION OF LUMINOUS FLOW is that of effecting the control and regulation of the luminous flow utilising the “partialisation of phase system” described before, but annulling all the disadvantages that are typical and offering absolutely all the advantages that characterise it.

Inside the GENERAL CONTROL MODULE two sub-sections are positioned, one with a RECTIFIER WITH A CORRECTOR OF THE FACTOR OF ACTIVE POWER, and one with a WAVE FORM GENERATOR:

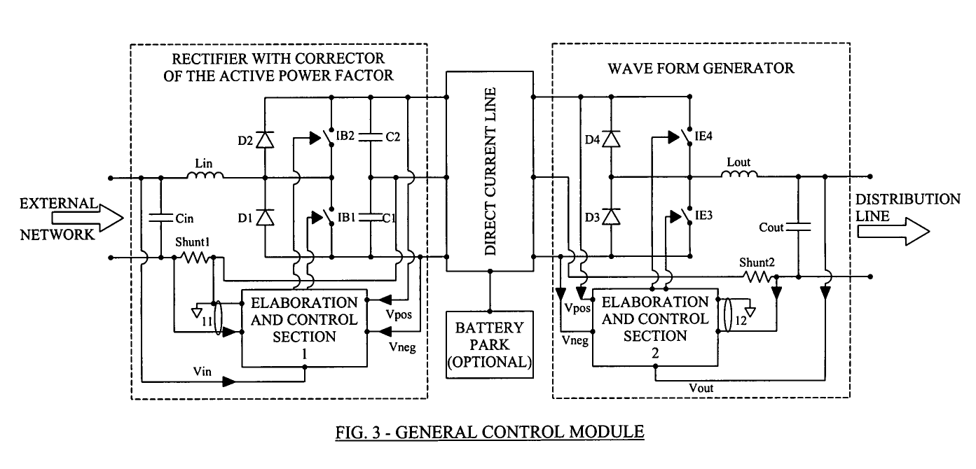

The section with the RECTIFIER WITH A CORRECTOR OF THE FACTOR OF ACTIVE POWER is placed at the end of the “External Network” and at the start of the “Line in DirectCurrent”. The scope of this section is that of effecting the conversion AC/DC and, via its “Section of Elaboration and Control” and the Electronic Interrupters IE1 and IE2, effecting the correction of the power factor in such a way as to absorb from the network a current of the sinusoidal type that respects the present regulations. In FIG. 3 the trial circuit used by us in the prototype constructed has been designed; the design presented operates in mono phase but results as being easily extended also in the case of tri-phase.

The section of the WAVE FORM GENERATOR is, instead, placed at the end of the “Line of DirectCurrent” and at the start of the “Line of Distribution”. The scope of this section is that of effecting the AC/DC conversion and, via its “Section of Elaboration and Control” and the Electronic Interrupters, IE3 and IE4, to generate wave forms different from the network standards which will go to feed, via the “line of Distribution”, the MODULES OF CONTROL AND REGULATION OF THE LUMINOUS FLOW and thus the lamps connected to it. In FIG. 3 the trial circuit used by us in the prototype constructed has been designed.

Having constructed a double conversion system in which a “continuous feed junction” is present, allows the insertion of a “battery park” in an easy manner (a font typical of directcurrent), and avoiding to the system, with a notable reduction in cost, the turning off of the lamps in the case of a blackout.

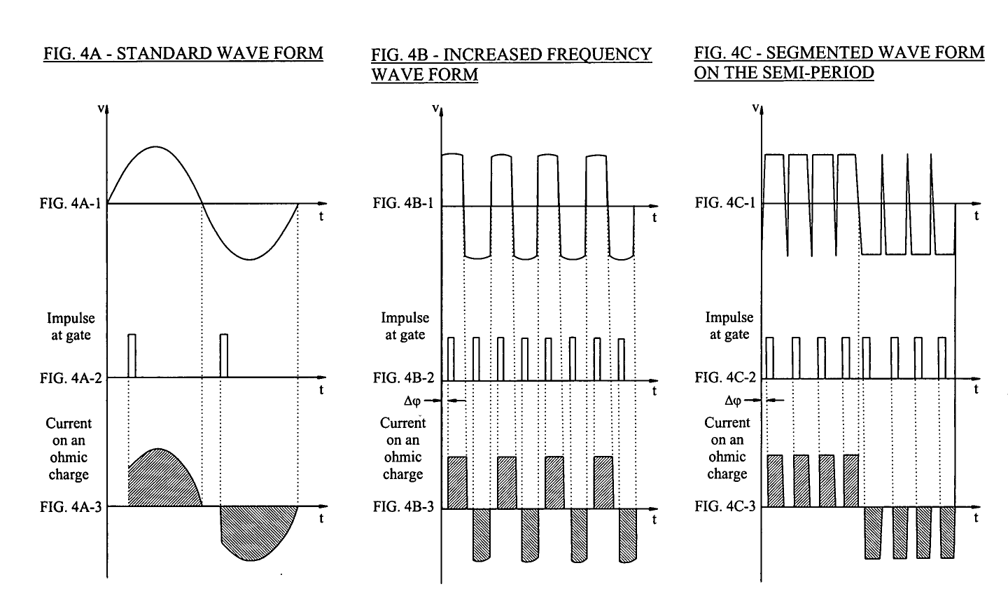

To better describe the functional conception of our system it is possible to refer to FIGS. 4A, 4B, and 4C, where:

4.1. The FIG. 4A repeats what has already been illustrated in FIG. 2C. The diagram is repeated with the sole scope of putting the reader into an easier condition for making a paragon, consequently the same observations made in precedence are still the case.

4.2. The FIG. 4B illustrates the functional conception of the system in the case in which the WAVE FORM GENERATOR, operates generating a trapezoidal wave form with a frequency greater than that furnished by the network. This wave form will from here onwards be denominated as a FREQUENCY MULTIPLIED WAVE.

4.3. The FIG. 4C illustrates the functional conception of the system in the case in which the WAVE FORM GENERATOR operates generating a segmented wave form in its nominal frequency. By the term “segmented wave” we intend a wave which in some or all of its semi periods contains portions of a wave in a contrary direction of an adjustable life, as shown in FIG. 4A-1. This wave form will from here onwards be denominated as a SEGMENTED FREQUENCY WAVE.

Referring to the FIG. 4B it becomes evident that by programming the WAVE FORM GENERATOR in the manner which permits it to furnish a FREQUENCY MULTIPLIED WAVE, the “Line of Distribution” will be fed with a wave form as appears in FIG. 4B-1.

Consequently, if the MODULE OF CONTROL AND REGULATION OF THE LUMINOUS FLOW supplies an impulse to its own power system of the type shown in FIG. 4B-2, 2, then the luminous flow that the lamp connected to it generates is reduced in a way relative to the retarding of phase (Δφ) carried by the impulse. This method also has the intrinsic advantage of operating with an impedance of reduced dimension on the lamp. In fact, XL being=ω·L, the same XL will be obtained with a value of L of the lesser impedance, the operating rrequency being increased and therefore the value of ω(ω=2·π·f). A result that permits, in a very easy manner (thanks to the improved parameters of weight/space), to modify existing equipment.

Furthermore, it also results as possible to maintain constant the power supplied to the lamps with variations in voltage in the network and/or of the charge connected, even varying the operative frequency (fop) of the wave form generated by the WAVE FORM GENERATOR with respect to the network frequency(fn). This is because, as previously

specified, the impedance (L) connected in series to the lamp modifies its value of induction (XL=ω·L) and thus the current that passes to the lamp, allowing this last to supply the correct value of luminous flow.

Allowing that the partialisation of phase acts in an exclusively subtractive manner, that is, from a prefixed maximum value, characterised by a phase shift (Δφ) between the signal entering and the impulse at the gate equal to zero degrees, increasing the phase shift between these two sizes.

In designing our prototype we calculated the impedance to be placed in series at the lamp, in such a way that it functions at its nominal current value, when the operative current voltage reaches its maximum value. That value, specifically, has been placed at 265 Volts, a value equal to approximately 115% of the nominal value (230 Volts).

This experimental configuration permits the regulation of the luminous flow of each single light point with a high number of intermediate stages, and thus with a good definition, and furthermore:

a.1. The peaks of rapid surge voltage in the external network are unable to significantly interest the WAVE FORM GENERATOR, thanks to the filter condensers present on the directcurrent section of the RECTIFIER WITH A CORRECTOR OF THE ACTIVE POWER FACTOR;

a.2. The WAVE FORM GENERATOR can compensate for eventual surges of voltage with a “Dead Time” (an English expression, now in standard use) action, by which is indicated the method of commanding a power system, leaving open both the electronic interrupters IE3 and IE4 (see FIG. 3) in order to reduce the area of the wave form generated:

a.3. The MODULE OF CONTROL AND REGULATION OF THE LUMINOUS FLOW operates with a decidedly higher dynamic (a greater number of intermediate stages in the same amount of time), thanks to the greater frequency available.

The operative mode that permits the WAVE FORM GENERATOR to supply a FREQUENCY MULTIPLIED WAVE, although excellent, has the grave handicap of not being easily capable of adapting to operate in automatic by-pass conditions (an expression that indicates the possibility of inserting a commutator which, in the case of a failure of the main system, feeds the charge directly from the external network); a functional difficulty that reduces the parameters of MTBF (an English acronym for the average time between failures) in the system.

With the scope of avoiding these problems and giving the best possible characteristics of reliability to the system, we recommenced research, pointing this time towards finding a solution capable of operating with the same impedance foreseen by the makers of the lamp (in such a way as to make possible the functioning of our apparatus even in operative conditions of automatic by-pass), still maintaining the same performance guaranteed by the FREQUENCY MULTIPLIED WAVE.

From this research we have developed the wave form shown in FIG. 4C-1, called SEGMENTED FREQUENCY WAVE, the most important characteristic parameters of which are:

b.1. The duration time of the portion of the wave towards the reverse, which should be as small as possible in order to avoid a reduction of the energy potentially available (in the course of the description this problem will be made clearer);

b.2. The nominal frequency of the Line of Distribution which, similar to the preceding procedure, is decided in such a way that (without modifying the impedance given by the makers, so that the system can operate even in automatic by-pass conditions), in the most extreme functional conditions, that is phase shift (Δφ) between the entrance signal and the impulse on the gate equal to zero degrees, and with a project maximum operative current voltage (specifically equal to 265 Volts, that is 115% greater than its nominal value, 230 Volts), the circuit operates in its nominal conditions.

A system is therefore obtained that, even in its different operative conception, possesses the same performance standards as the precedent method (a high number of intermediate stages of regulation of the luminous flow of each single light point), without having functional difficulties in operating in automatic by-pass configurations and thus able to effect the commutation between the external network and our apparatus without problem.

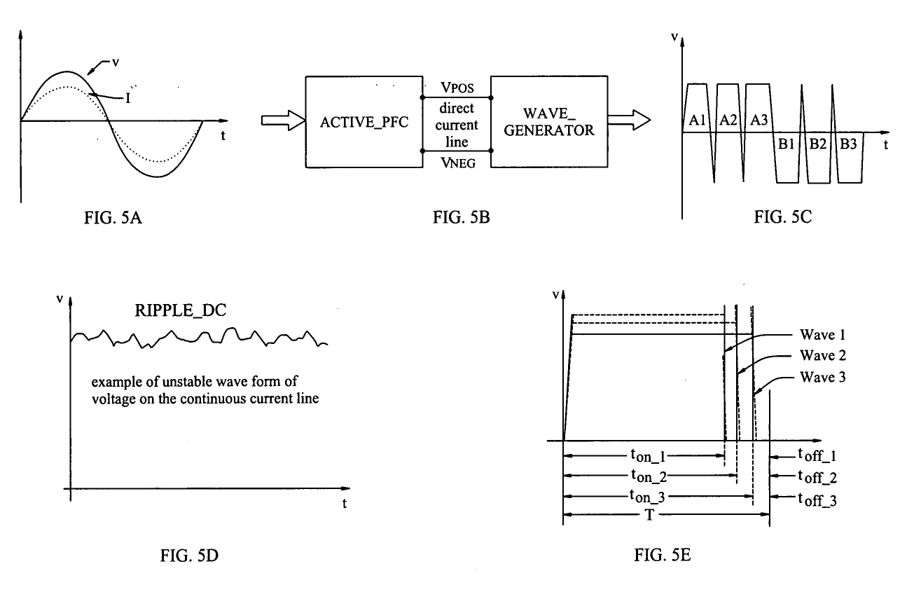

A configuration of this kind thus operates feeding the line of internal distribution, where the lamps are connected, with a wave form different to the external network standard in its frequency and wave form parameters. As a result, it is evident how it is necessary to re-establish a certain “compatibility” at the point of connection of our apparatus with the external network, where precise regulations demand the respect of some operating parameters. To actuate this compatibility the RECTIFIER WITH A CORRECTOR OF THE ACTIVE POWER FACTOR is responsible; effecting, in fact the correction of the power factor. A number of publications exist, dealing with the function of such devices, so we shall not linger any longer on the argument in this document. What we principally want to underline, rather, is the “disturbing action” that it exercises on the “Line of Direct Current” that feeds the WAVE FORM GENERATOR, and how this implicates the necessity of giving this device a “compensatory circuit” capable of giving the system a good level of stability of the luminous flows generated by the various lamps. In FIG. 5B is shown the design of the MODULE OF GENERAL CONTROL, and of its under-sections the RECTIFIER WITH A CORRECTOR OF THE ACTIVE POWER FACTOR and the WAVE FORM GENERATOR. It appears evident therefore that:

c.1. The RECTIFIER WITH A CORRECTOR OF THE ACTIVE POWER FACTOR will continue, as is seen in FIG. 5A, to operate until the wave form of the current incoming is of a sinusoidal form (at least to the measure demanded by regulations) and in phase with the current voltage, in order to avoid the useless consumption/cost of the reactive energy;

c.2. The WAVE FORM GENERATOR will instead continue, as is visible in FIG. 5C, to generate the type of wave (in frequency and in form), that the distribution line requires (in the example in the design a FREQUENCY SEGMENTED WAVE is shown, with three segments on the nominal frequency).

As a result it is also obvious that the “Line in Direct Current”, undergoing a difficult “connecting action” between the necessities illustrated in point “c.1” and those illustrated in point “c.2”, undergoes the continuous variations in value that generate a “ripple” on the directcurrent, whose signal from hereon in the description will be indicated as “RlPPLE-DC”.

The RIPPLE-DC signal, for which the FIG. 5D provides a possible example, is produced by the sum of four different causes, in synthesis as:

d.1. The instability of the current tension of the network;

d.2. The impulses of the RECTIFIER WITH A CORRECTOR OF THE ACTIVE POWER FACTOR, which, in order to absorb a sinusoidal current from the network, disturb the level of directcurrent;

d.3. Variations of the power absorbed by the connected charge;

d.4. Variations of the current because of the WAVE FORM GENERATOR during the development of its operative sequences.

A pool of factors that vary, with a high dynamic, the energy that the specific semi-period or turning off in examination can supply. These continual variations affect, in fact, the energy that is of interest to the lamp (and thus its luminous flow), making it factually impossible to effect a good stability of the luminosity desired. We further underline that when the lamp operates at low luminosity, it becomes important that the stabilization operates with a high number of stages in order to avoid erroneous turnings off of this last.

The correction technique set up by our apparatus aims to act on the WAVE FORM GENERATOR in such a way that the various areas of “tension-time” that are generated are all perfectly equal between them; it follows that if the current tension increases with respect to the value foreseen, the WAVE FORM GENERATOR proportionately reduces its activation time (ton). See FIG. 5E to this aim.

The reduction in the activation time “ton” brings the introduction of a time in which the current voltage value is zero, in the case of the FREQUENCY MULTIPLIED WAVE, or in inversion to that of the semi-period in course, in the case of the FREQUENCY SEGMENTED WAVE. Such time in the first case will be denominated time off, or “toff”, and in the second case the inversion time, or “trev”.

The turning off time “toff”, in the case of a FREQUENCY MULTIPLIED WAVE, or of inversion “trev”, in the case of a FREQUENCY SEGMENTED WAVE, therefore has the double scope of;

e.1. Generating semi periods, in the case of a FREQUENCY MULTIPLIED WAVE, or segments, in the case of a FREQUENCY SEGMENTED WAVE, with a constant energy potential;

e.2. Supply the “ton” and the “toff” or the “trev” of the semi period or the segment in exam to the MODULE OF CONTROL AND REGULATION OF THE LUMINOUS FLOW, so that via these data they can elaborate the successive command of “phase partialisation” to carry out to maintain stable, on the programmed value, the luminous flow of the lamps controlled by them.

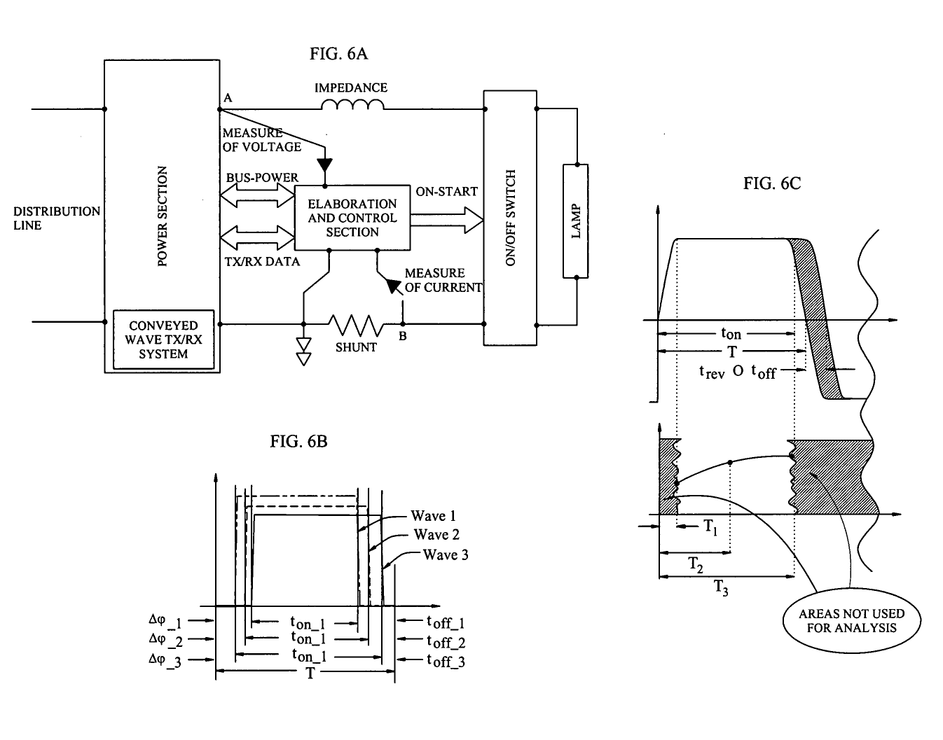

The design of the MODULE OF CONTROL AND REGULATION OF THE LUMINOUS FLOW is shown in FIG. 6. This module has, as a fundamental unit, a “Section of Elaboration and Control” and a “Power Section”. The functional principle that regulates the MODULE OF CONTROL AND REGULATION OF THE LUMINOUS FLOW is the following:

f.1. Via a specific bus for the reception and transmission of data, denominated “TX/RX DATA”, the various MODULES OF CONTROL AND REGULATION OF THE LUMINOUS FLOW dialogue with the MODULE OF GENERAL CONTROL, in order to acquire the necessary data for the various elaborations and, at the same time, supply the data about its own functional conditions.

f.2. Using the data supplied by the MODULE OF GENERAL CONTROL, together with the measure of the voltage and the current (points A and B in FIG. 6A), the “Section of Elaboration and Control” is capable of elaborating the correct commands so that the lamp operates in the programmed modes.

f.3. The “Section of Elaboration and Control”, via a specific interconnecting bus denominated “POWER BUS”, transmits the necessary commands to the “Power Section” so that the lamp operates in the programmed mode.

The power section, according to the type of wave supplied by the WAVE FORM GENERATOR, can configure itself in various modes (structure of the FREQUENCY MULTIPLIED WAVE type or with a FREQUENCY SEGMENTED WAVE), and the same also with the electronic interrupters present in it that can also be of a diverse type: from those that do not foresee (thanks to the frequent transits of the current on the zero), the possible turning off command (for example the TRIACs), to those which, to operate with a good dynamic, need circuits that are capable of actuating their own turning off without waiting for the passage to zero (like the IGBTs and the MOSFETs).

The auxiliary circuitry constituted by the impedance and by the on switch (the rephasing condenser is not included because, in our case, it becomes an integrated component in the power section), utilised in the circuit can be, on the basis of the specific circuital solution adopted, both that supplied by the lamp's manufacturer and that of components prepared by us for that scope. It is interesting to note that in the second case it is possible to run the on switch of the “Section of Elaboration and Control” via a special command denominated “On-Start” (obtaining a better quality of action and checking).

To better specify the operative mode of the “Section of Elaboration and Control” of the MODULE OF CONTROL AND REGULATION OF THE LUMINOUS FLOW it is possible to refer to the FIG. 6B where it is shown how, according to the form of wave generated by the WAVE FORM GENERATOR, in which the semi periods, in the case of a FREQUENCY MULTIPLIED WAVE, or the segments, in the case of a FREQUENCY SEGMENTED WAVE, present a constant energy potential (see FIG. 5E), the MODULE OF CONTROL AND REGULATION OF THE LUMINOUS FLOW supplies a form of wave capable of making the lamp connected to it generate the luminous flow programmed, by the method of partialisation of phase (that is by varying the Δφ).

Inherently with the control/checking of the function of the lamp and its auxiliary circuitry our system needs (because of the “non standard” wave forms that characterise it) a different type of control from that of the actual standards (that use, for example, the measure of the phase shift between the tension and the current).

FIG. 6C makes evident precisely the operative conception actuated in our case, that we can illustrate thus:

h.1. Once the data of ton and trev or toff have been received from the MODULE OF GENERAL CONTROL, a PLL circuit (from the English Phase-Locked-Loop, that is a frequency multiplier synchronised to the frequency of reference) internal to its “Section of Elaboration and Control” generates a series of under multiples of the “T” period;

h.2. The internal elaborator of the “Section of Elaboration and Control”, utilising these under multiplies of the “T” period, calculates the correct temporal parameters to be used to acquire the instantaneous current measures necessary to characterise the form of wave of the current operating in the circuit. In this elaboration the measures of T, ton and trev or toff from the preceding period are used in the case of a functional condition with a FREQUENCY MULTIPLIED WAVE, or from the preceding segment in the case of a functional condition with a FREQUENCY SEGMENTED WAVE, maintaining the difference as negligible between these and those in the period. In our prototype, as shown in FIG. 6C, we characterised the curve of the current by three points, assigning as time “T1”, that immediately successive to the start transistors of the portion of the curve under exam, as time “T2”, that on the median point of the curve taken from the intersection of the measures of current, and as time “T3”, that immediately preceding the time trev or toff of the portion of wave under exam).

It is evident that a series of variations can be constructed on the number of the measures to be effected and/or on the times of measurement, the innovation that we want to underline is that, via one or more measures, actuated with the above described concept, it is possible to characterise, on a trapezoidal type of wave, the progress of the current on the lamp and from this, via a specific interpretative matrix, establish in an “unequivocal manner”: the emissive quality of the lamp and eventual problems present in its auxiliary circuits. We would like to underline, finally, a singular characteristic of our record of transmission/reception actuated by conveyed waves.

It is known that in a configuration such as ours, the principal problems are:

i.1. A single MODULE OF GENERAL CONTROL that must coordinate many MODULES OF CONTROL AND REGULATION OF THE LUMINOUS FLOW;

i.2. The MODULE OF GENERAL CONTROL may need to give rapid and general instructions, that is valid for many MODULES OF CONTROL AND REGULATION OF THE LUMINOUS FLOW connected to it (a typical example is the alarm information for black-outs in act, with the consequent and immediate necessity to modify the functional parameters to be able to operate with the “Battery Park”).

i.3. A difference of times between the transmission of the MODULE OF GENERAL CONTROL and those of the MODULE OF CONTROL AND REGULATION OF THE LUMINOUS FLOW (eventual misunderstandings create delays in the total response times).

These problems, together with some difficulties encountered because of the disturbances present on the line, suggested to us that we divide, in a net manner, the transmission times of the MODULE OF GENERAL CONTROL with respect to the MODULE OF CONTROL AND REGULATION OF THE LUMINOUS FLOW, assigning to the MODULE OF GENERAL CONTROL, as the moment of transmission, only the time in which the WAVE FORM GENERATOR operates in the positive semi period, while all the negative semi period is destined to the transmission of the MODULE OF CONTROL AND REGULATION OF THE LUMINOUS FLOW.

The experimental result was of notable value, in fact, even in conditions of disturbance, the speed of general command of the MODULE OF GENERAL CONTROL towards the MODULE OF CONTROL AND REGULATION OF THE LUMINOUS FLOW did not encounter significant delays. In this way, furthermore, we were able to diminish the reset time, that is the time necessary to re-establish once again the normal cycle of transmission, in the case of error in the protocol of transmission and reception of the data.

The utilisation of this type of protocol, which gives great relevance to the data transmitted by the MODULE OF GENERAL CONTROL, is essentially due to the fact that the data sent from the MODULE OF CONTROL AND REGULATION OF THE LUMINOUS FLOW are of an informative type towards the user, therefore the system does not encounter particular problems if the monitoring time (that is, the time for collecting the data transmitted from all the MODULES OF CONTROL AND REGULATION OF THE LUMINOUS FLOW to the MODULE OF GENERAL CONTROL) increases, while it remains important for a correct functioning of the entire system that the activation time for the commands, emitted by the MODULE OF GENERAL CONTROL, should always be sufficiently rapid and reliable.

What is claimed is:

1. A system for controlling and regulating continuously the luminous flow of every single lamp derived on a parallel line constituted of a general control module placed at the entrance to the network of external feed and of control and regulation modules each placed on every single lamp connected to the parallel distribution line and characterised by the fact that: The general control module is constituted of a rectifier implemented by a section of elaboration and control (furnished with opportune electronic interrupters), that effects the correction of the power factor in an active manner, and of a wave form generator implemented by a section of elaboration and control (furnished with opportune electronic interrupters), that produces wave forms of a type and frequency different to those of the standard network and that transmits and receives data via the parallel distribution line utilising a transmission and reception protocol on conveyed waves with every single module of control and regulation of the luminous flow. The module of control and regulation of the luminous flow is composed of a section of elaboration and control and of a power section, it carries out the control and the regulation of the luminous flow of the lamp to which it is connected and transmits and receives data via the parallel distribution line, utilising a transmission and reception protocol on conveyed waves with the general control module.

2. A system for controlling and regulating continuously the luminous flow of every single lamp derived on a parallel line according to claim 1, characterised by the fact that the electronic interrupters of the rectifier of the general control module are IGBT or MOSFET, that the electronic interrupters of the wave form generator of the general control module are IGBT or MOSFET, that the electronic interrupters of the power section of the control and regulation of the luminous flow module are TRIAC or IGBT or MOSFET.

3. A system for controlling and regulating continuously the luminous flow of every single lamp derived on a parallel line according to claim 1, characterised by the fact that the wave form generator of the general control module produces frequency wave forms larger than the network standard.

4. A system for controlling and regulating continuously the luminous flow of every single lamp derived on a parallel line according to claim 1, characterised by the fact that the wave form generator of the general control module that produces wave forms in one or more semi periods contains portions of waves of a contrary direction to that of the semi period and of adjustable time length.

5. A system for controlling and regulating continuously the luminous flow of every single lamp derived on a parallel line according to claim 1, characterised by the fact that the wave form generator of the general control module maintains constant the power supplied to the lamps connected on the parallel distribution line by varying the frequency of the signal.

6. A system for controlling and regulating continuously the luminous flow of every single lamp derived on a parallel line according to claim 3 or 4, characterised by the fact that the wave form generator of the general control module maintains constant the power supplied to the lamps connected to the parallel distribution line, reducing the conduction time of the electronic interrupters placed on it.

7. A system for controlling and regulating continuously the luminous flow of every single lamp derived on a parallel line according to claim 5, characterised by the fact that the section of elaboration and control of the module of control and regulation of the luminous flow, receiving from the wave form generator of the general control module the wave frequency generated by it, elaborates the correct command to send to the power section of the module of control and regulation of the luminous flow, so that the luminous flow of the lamp connected to it is reduced by the programmed value.

8. A system for controlling and regulating continuously the luminous flow of every single lamp derived on a parallel line according to claim 1, characterised by the fact that the section of elaboration and control of the module of control and regulation of the luminous flow establishes the functions of the lamp connected to it and of its auxiliary circuits, effecting one or more measurements of the instantaneous current that passes through the lamp.

9. A system for controlling and regulating continuously the luminous flow of every single lamp derived on a parallel line according to claim 6, characterised by the fact that the section of elaboration and control of the module of control and regulation of the luminous flow, receiving from the wave form generator of
the general control module the conduction time of the electronic interrupters placed on it, elaborates the correct command to send to the power section of the module for control and regulation of the luminous flow, so that the luminous flow of the lamp connected to it is reduced by the programmed value.

10. A system for controlling and regulating continuously the luminous flow of every single lamp derived on a parallel line according to claim 1, characterised by the fact that the protocol of transmission and reception between the general control module and the module of control and regulation of the luminous flow assigns the transmission of the general control module to a specific semi period and the transmission of the module of control and regulation of the luminous flow to the semi period in the opposite direction.
